(19) United States
(12) Patent Application Publication
(10) Pub. No.: US 2025/0056483 A1
(43) Pub. Date: Feb. 13, 2025

(54) HANDLING VIOLATIONS OF SLPP SESSION PARAMETER CONFIGURATION

(71) Applicant: Nokia Technologies Oy, Espoo (FI)

(72) Inventors: Anastasios KAKKAVAS, Munich (DE); Stepan KUCERA, Munich (DE); Diomidis MICHALOPOULOS, Munich (DE); Taylan SAHIN, Munich (DE); Prajwal KESHAVAMURTHY, Munich (DE)

(21) Appl. No.: 18/797,509

(22) Filed: Aug. 8, 2024

Related U.S. Application Data
(60) Provisional application No. 63/531,889, filed on Aug. 10, 2023.

(51) Int. Cl. H04W 64/00; H04L 5/00; H04W 24/10; H04W 92/18

(52) U.S. Cl. CPC H04W 64/00; H04L 5/0051; H04W 24/10; H04W 92/18

(57) ABSTRACT

A first device in a wireless network receives, from a second device in the wireless network, a report of violation of parameter(s) for positioning of the second device using SLPP. The first device applies corrective measure(s) to mitigate an effect of the violation. In a wireless network having a first device and a second device, the second device determines a violation of parameter(s) has occurred for positioning of the second device using SLPP. The second device sends, to a first device, a report of the violation of the parameter(s).

### TECHNICAL FIELD

Examples of embodiments herein relate generally to sidelink (SL) communications and, more specifically, relate to violations of parameters in configurations for Sidelink Positioning Protocol (SLPP) and their handling.

### BACKGROUND

Sidelink (SL) communications refer to the direct communication between UEs (user equipment, i.e., wireless and typically mobile devices connected to a cellular network) without involving a traditional cellular network infrastructure. In SL communications, UEs can exchange data directly with nearby UEs, forming ad-hoc networks. An advantage of sidelink communications is low-latency and high-throughput connections, enabling new applications and services that require real-time communication or operate in a localized area. A typical use case is communication between vehicles, such as for emergency situations.

The Sidelink Positioning Protocol (SLPP) is a feature that allows UEs to determine their absolute or relative positions to other UEs in their vicinity without necessarily relying on centralized positioning systems. This is particularly useful for applications that require precise local positioning information, such as asset tracking, navigation in indoor environments, and proximity-based services.

The SLPP leverages the SL communication capabilities of UEs to perform measurements and exchanges of positioning-related information between nearby UEs. By measuring the time-of-arrival (ToA), time difference of arrival (TDoA), and/or angle of arrival (AoA) of signals exchanged between UEs, it is possible to calculate their positions accurately.

For SLPP sessions for a UE, there are certain parameters and corresponding configuration that are used to enable position determination. Should a violation of those parameters occur, the UE typically does not perform positioning.

### BRIEF SUMMARY

This section is intended to include examples and is not intended to be limiting.

In an exemplary embodiment, a method is disclosed that includes receiving, by a first device in a wireless network from a second device in the wireless network, a report of violation of one or more parameters for positioning of the second device using sidelink positioning protocol; and applying, by the first device, one or more corrective measures to mitigate an effect of the violation.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: receiving, by a first device in a wireless network from a second device in the wireless network, a report of violation of one or more parameters for positioning of the second device using sidelink positioning protocol; and applying, by the first device, one or more corrective measures to mitigate an effect of the violation.

An exemplary computer program product includes a computer-readable storage medium bearing instructions that, when executed by an apparatus, cause the apparatus to perform at least the following: receiving, by a first device in a wireless network from a second device in the wireless network, a report of violation of one or more parameters for positioning of the second device using sidelink positioning protocol; and applying, by the first device, one or more corrective measures to mitigate an effect of the violation.

In another exemplary embodiment, an apparatus comprises means for performing: receiving, by a first device in a wireless network from a second device in the wireless network, a report of violation of one or more parameters for positioning of the second device using sidelink positioning protocol; and applying, by the first device, one or more corrective measures to mitigate an effect of the violation.

In an exemplary embodiment, a method is disclosed that includes in a wireless network having a first device and a second device, determining, by the second device, a violation of one or more parameters has occurred for positioning of the second device using sidelink positioning protocol; and sending, by the second device to the first device, a report of the violation of the one or more parameters.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: in a wireless network having a first device and a second device, determining, by the second device, a violation of one or more parameters has occurred for positioning of the second device using sidelink positioning protocol; and sending, by the second device to the first device, a report of the violation of the one or more parameters.

An exemplary computer program product includes a computer-readable storage medium bearing instructions that, when executed by an apparatus, cause the apparatus to perform at least the following: in a wireless network having a first device and a second device, determining, by the second device, a violation of one or more parameters has occurred for positioning of the second device using sidelink positioning protocol; and sending, by the second device to the first device, a report of the violation of the one or more parameters.

In another exemplary embodiment, an apparatus comprises means for performing: in a wireless network having a first device and a second device, determining, by the second device, a violation of one or more parameters has occurred for positioning of the second device using sidelink positioning protocol; and sending, by the second device to the first device, a report of the violation of the one or more parameters.

### BRIEF DESCRIPTION OF THE DRAWINGS

In the attached drawings:

FIG. 1 is an illustration of an SL positioning scenario;

FIG. 2 illustrates an exemplary message flow using a signaling diagram for handling of an SPP session parameter violation;

FIG. 2A illustrates possible examples of embodiments for step 3 of FIG. 2;

FIG. 2B illustrates possible examples of embodiments for step 4 of FIG. 2;

FIG. 2C illustrates possible examples of embodiments for step 5 of FIG. 2;

FIG. 2D illustrates possible examples of embodiments for step 6 of FIG. 2; and

FIG. 3 is a block diagram of one possible and non-limiting exemplary system in which the exemplary embodiments may be practiced.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as “or”, “and”, or “both”. As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

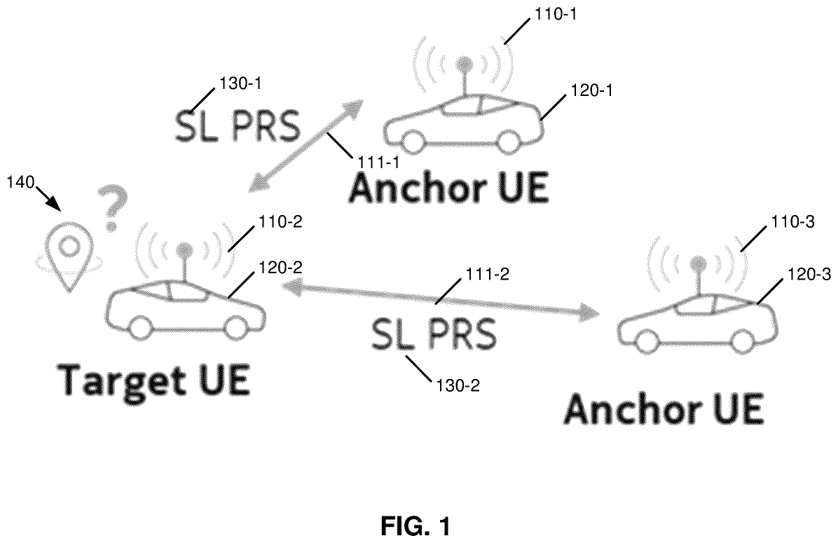

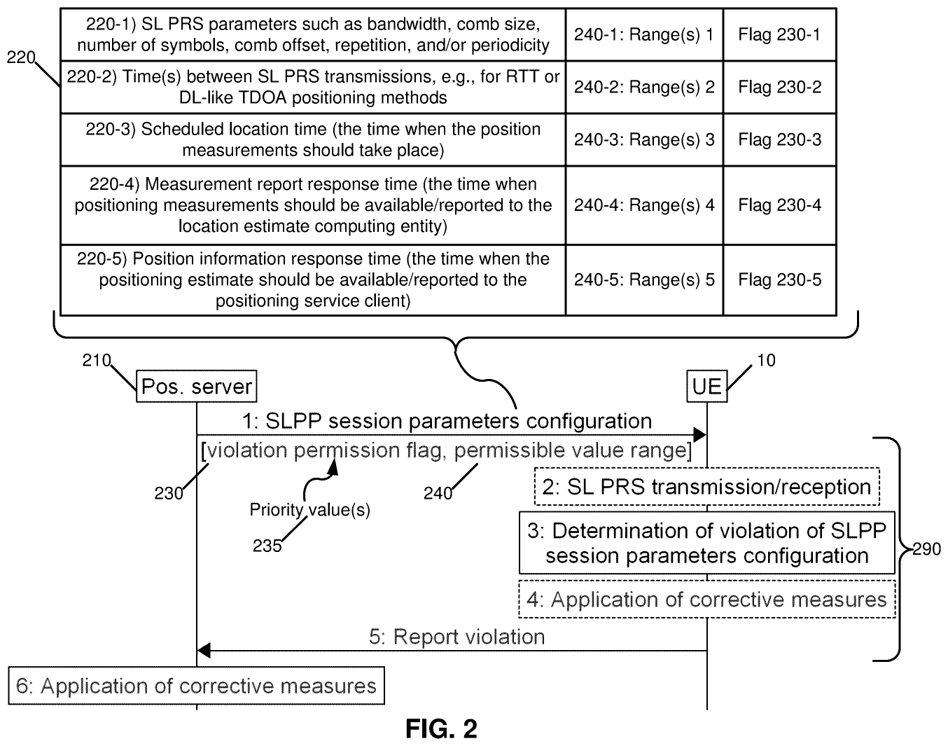

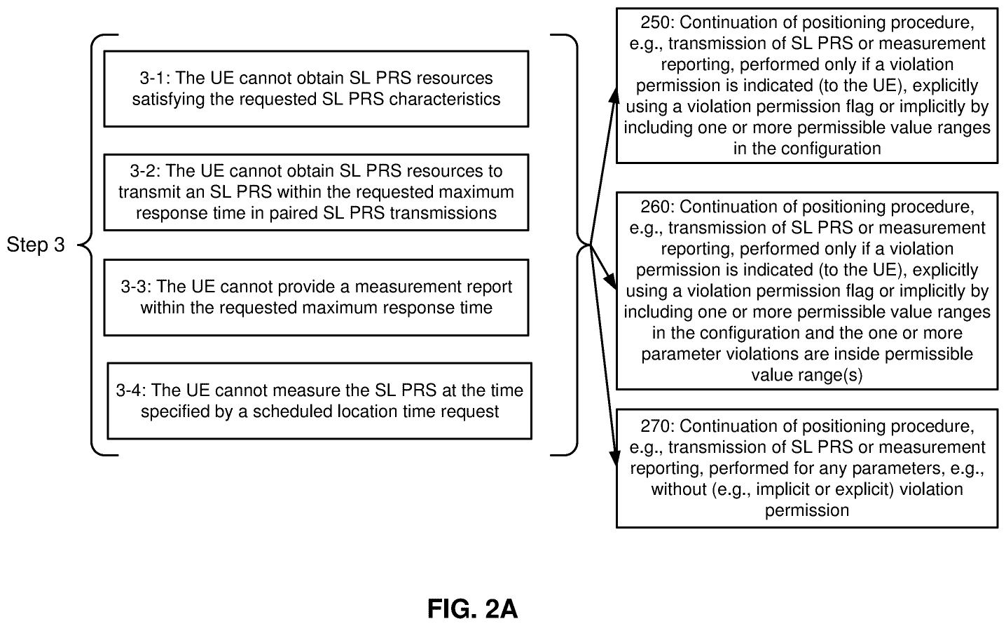

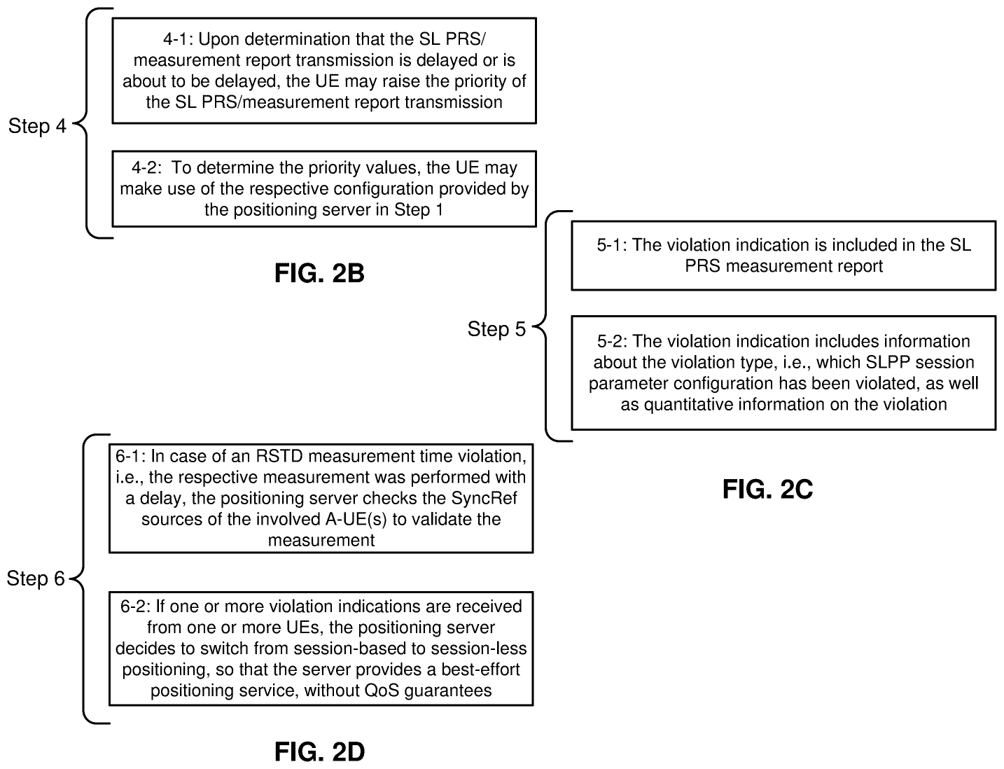

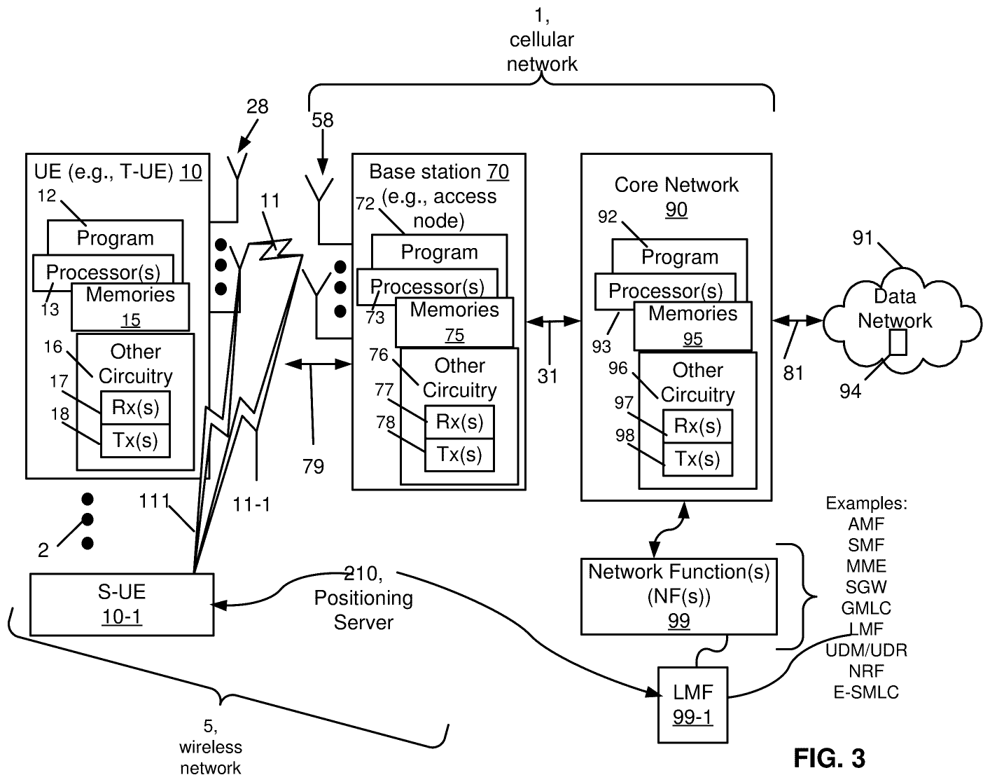

Any flow diagram or signaling diagram (such as FIG. 2, 2A, 2B, 2C, or 2D) herein is considered to be a logic flow diagram, and illustrates the operation of an exemplary method, results of execution of computer program instructions embodied on a computer readable memory, functions performed by logic implemented in hardware, and/or interconnected means for performing functions in accordance with an exemplary embodiment. Block diagrams (such as FIGS. 1 and 3) also illustrate the operation of an exemplary method, results of execution of computer program instructions embodied on a computer readable memory, functions performed by logic implemented in hardware, and/or interconnected means for performing functions in accordance with an exemplary embodiment.

Below is a list of related terminologies.

Target UE (T-UE): UE to be positioned (in this context, using SL, i.e., PC5 interface).

Anchor UE (A-UE): UE supporting positioning of target UE, e.g., by transmitting and/or receiving reference signals for positioning, providing positioning-related information, or the like, over the SL interface.

Server UE (S-UE): SL Positioning Server UE: A UE offering method determination, assistant data distribution and/or location calculation functionalities for sidelink positioning and ranging based service.

Sidelink positioning: Positioning UE using reference signals transmitted over SL, i.e., PC5 interface, to obtain absolute position, relative position, or ranging information.

Ranging: Determination of the distance and/or the direction between a UE and another entity, e.g., anchor UE.

Sidelink positioning reference signal (SL PRS): Reference signal transmitted over SL for positioning purposes.

SL PRS (pre-) configuration: (Pre-) configured parameters of SL PRS such as time-frequency resources (other parameters are not precluded) including its bandwidth and periodicity.

SL positioning is based on the transmissions of positioning reference signal SL-PRS between the anchor and target UEs to enable localization of the target UE within precise latency and accuracy requirements of the corresponding SL positioning session. FIG. 1 illustrates an SL positioning scenario where a target UE is performing SL positioning session, i.e., exchanging SL-PRS with two anchor UEs to determine its location. Specifically, the target UE (T-UE) 110-2 in automobile 120-2 exchanges SL-PRS 130-1 and 130-2 with two anchor UEs 110-1 and 110-3 in corresponding automobiles 120-1 and 120-3 and over corresponding a sidelink 111-1 or 111-2 to determine its location (as indicated by reference 140).

Before and after the transmission and measurement of the SL PRSs, a series of steps must take place to enable SL positioning. Within the steps to enable SL positioning, the T-UE(s) and A-UE(s) are configured by the Location Management Function (LMF) or the S-UE to transmit/receive SL PRS. The LMF/S-UE (referred to as a positioning server herein) may provide the UEs with a list of requested SL PRS characteristics, which may include, for example, the SL PRS bandwidth, comb size, periodicity, start time and/or duration, or the like.

The T-UE(s) and A-UE(s) are configured to provide location information, e.g., measurements, to the LMF/S-UE, i.e., they receive a configuration of what, how and when to report. For example, the UEs may receive a scheduled location request, with which they are requested to obtain location measurements or location estimate valid at a specified time. In addition, the UEs may be configured with a maximum response time. Furthermore, requirements on the accuracy of location estimates may be provided.

To carry out the SL positioning-related operations, the UEs obtain appropriate time-frequency resources. The resource allocation may be performed in a UE-autonomous (scheme-2) manner.

There are multiple techniques to address what happens when there is a violation related to positioning over the SL. For instance, in NRPPa [see 3GPP TS 38.455 V17.5.0 (2023-06)], the LMF requests from the NG-RAN nodes, e.g., gNBs, a specific DL PRS configuration with a “PRS CONFIGURATION REQUEST” message [3GPP TS 38.455, section 8.2.11.3] or a specific UL SRS for positioning configuration with “Requested SRS Transmission Characteristics” information element in the “POSITIONING INFORMATION REQUEST” message. The NG-RAN nodes allocate resources for the DL PRS/UL SRS transmission. If they fail to allocate the resources, the NG-RAN nodes respond with a “PRS CONFIGURATION FAILURE”/“POSITIONING INFORMATION FAILURE” message to the LMF.

As another example, in LPP [sce 3GPP TS 38.455 V17.5.0 (2023-06)], if the UE cannot provide location information as requested in a “RequestLocationInformation” message, the UE replies with an error message.

Although there are multiple techniques to address what happens when there is a violation related to positioning over the SL, there are still unresolved issues. The nature of scheme-2 resource allocation, where UEs compete for a limited set of resources in an autonomous manner, may lead to significant challenges in satisfying the requested characteristics of SL PRS transmission and measurement provision, which may impact localization quality.

For example, scheduling delay may prevent timely measurement for a scheduled location request or timely data delivery within the configured maximum response time. Furthermore, a synchronization reference (SyncRef) change may happen during a delayed SL PRS transmission, which may impact the OTDOA measurement quality. In that case, location data delivery may exceed the configured response time. Such violation of the configured response time should be reported to the positioning server for the latter to provide corrective measures, though there is no such consideration in the specifications.

As another example, the UEs may be unable to obtain the requested SL PRS bandwidth and may, as a result, transmit an SL PRS with reduced bandwidth. Again, this is another violation of the configured SL PRS resources, which need to be updated to the positioning server for the latter to provide alternative requested actions.

It is highlighted that such events are far more likely to happen in SL positioning as compared to Uu-based (between UE and network) positioning. The reason is that in Uu positioning, the resources are controlled by the network, whereas in SL positioning there are multiple devices involved that often control their resources in a scheme-2 fashion, hence the availability of resources is much more dynamic and such updates need to be provided to the positioning server.

As a result, there can be several practical cases where the requirements for SL PRS transmission are not met exactly as requested, though still some “violation” of the set requirements can be acceptable for maintaining the continuity of a positioning session. However, there is no such consideration in the SL positioning specifications.

This is an example of a gap the techniques herein address. An overview is provided now, and further details are provided below, with respect to these techniques.

In an example, although the requirements for positioning using SLPP are not met for a positioning session, the UE continues with a positioning session, but the UE notifies the positioning server about the issue. One benefit of such an approach is that interruption of the positioning service is avoided, while allowing the positioning server (or the UE) to take corrective measures. In other words, the techniques herein are means to enable that, in case of a violation, the positioning service continues, e.g., in a best effort basis (until a potential corrective action is taken). This may be very important in SL, especially in scheme-2 (i.e., UE-autonomous) resource allocation where the competition of the limited time-frequency resources may lead to a large number of cases where requirements, e.g., on BW or delay, cannot be met. As is known, scheme-2 resource allocation is the UE-autonomous resource allocation technique for SL PRS, similar to the legacy mode-2 resource allocation for SL communications, while scheme-1 is resource allocation controlled by the network, e.g., a gNB, similar to the legacy mode-1 resource allocation for SL communications. The techniques herein can benefit both schemes, although could benefit scheme-2 more in certain situations.

As one example, a method is proposed to enable that the SL positioning procedure is carried on when requirements on SL PRS transmission and/or measurement provision cannot be met and to make the positioning server, e.g., the LMF or the S-UE, aware of such occurrences, so that the positioning server may take appropriate action.

To this end, the positioning server may inform the UEs whether a violation of the requested configuration is allowed. Alternatively or additionally, SLPP session parameters (e.g., measurement report time) and SL PRS parameters (e.g., bandwidth, comb size, “response” timing in paired RTT transmissions) are defined by a permissible value range, e.g., in terms of a min and/or max permissible value. This is a new concept, useful for maintaining the continuity of positioning sessions.

If the permissible value range is violated, the UE reports the violation and potentially provides detailed information on it. Alternatively or additionally, the UE may apply a corrective measure to mitigate the effect of the violation or avoid such further occurrences. The positioning server, upon reception of a violation indication, may apply a corrective measure to mitigate the effect of the violation or avoid such further occurrences.

Now that an overview has been provided, further details are provided. An exemplary implementation of one example is depicted in FIG. 2, which illustrates an exemplary message flow using a signaling diagram for handling of an SPP session parameter violation. This is described using each of the steps in the figure.

Step 1: The positioning server 210 provides the SLPP session parameters configuration. The positioning server 210 may be, e.g., an LMF (in a core network) or a server US (S-UE). The SLPP session parameters configuration may include parameters 220 such as parameters of the (requested) SL PRS configuration and/or parameters of the measurement report configuration, including permissible ranges for at least one or more of the following:
220-1) SL PRS parameters such as bandwidth, comb size, number of symbols, comb offset, repetition, and/or periodicity.
220-2) Time(s) between SL PRS transmissions, e.g., for RTT or DL-like TDOA positioning methods.
220-3) Scheduled location time (the time when the position measurements should take place).
220-4) Measurement report response time (the time when positioning measurements should be available/reported to the location estimate computing entity).
220-5) Position information response time (the time when the positioning estimate should be available/reported to the positioning service client).

Along with the configuration, the following may be provided:
1) A violation permission flag 230 may be included to explicitly indicate to the UE whether, in response to a violation of the provided SLPP session parameters occurring, the UE should continue with its SL positioning session-relevant actions, e.g., SL PRS transmission, SL PRS measurement, SL PRS measurement report, potentially also providing information about the violation as per configuration.
2) Priority values 235 that may be used by the UE in case an (e.g., imminent) delay violation is detected, as described in Embodiment 4-1 below, may be included.
3) Permissible value ranges 240, which can apply to any or all of 220-1 through 220-5. In other words, any of 220 may have a permissible value range 240, e.g., in terms of a min and/or max permissible value. This is shown as an example with ranges 1 240-1 to 5 240-5, each corresponding to 220-1 through 220-5. For example, for 220-1, there could be a range 240-1 of bandwidth that is permissible. Furthermore, there could be multiple ranges 240 for more than one of the bandwidth, comb size, number of symbols, comb offset, repetition, and/or periodicity. For 220-2, where could be a range 240-2 for a time between SL PRS transmissions that is permissible. The others could be similarly defined with permissible value ranges 240. Permissible value ranges 240 are used to indicate to the UE what violation of the (requested) configuration may be tolerated by the positioning server.

Although each of the parameters 220 has a corresponding range 240 in this figure, this is only an example. One or more parameters 220 may have a corresponding range 240, or no parameters 220 may have a corresponding range 240.

Step 2: The UE, after obtaining SL time-frequency resources in case of SL PRS transmission, transmits or receives the SL PRS.

Step 3: The UE determines that the SLPP session parameters configuration has been violated. It is noted that step 2 or steps 2 and 3, in fact steps 1 to 5, might be part of a session 290. In more detail, in LPP (the specification for Uu-based positioning, that is DL or UL), a session might start with a message transmission from the location management function (LMF) or the UE and the session might terminate when the position information, which was requested in a request triggering the session establishment, reaches its destination. For SL positioning, the definition of the session and related message exchange are still under discussion. In LPP terminology, Step 1 could be in a “LOCATION INFORMATION REQUEST” message sent from the positioning server to the UE. However, this is merely one example, and the current extent of a “session” is not yet well-defined.

There are a number of possible embodiments, as shown in FIG. 2A, for step 3.

Embodiment 3-1: The UE cannot obtain SL PRS resources satisfying the requested SL PRS characteristics, e.g., the SL PRS bandwidth is smaller than request or the comb size is larger than requested. The SL PRS characteristics could be any or all of those indicated in 220-1.

Embodiment 3-2: The UE cannot obtain SL PRS resources to transmit an SL PRS within the requested maximum response time in paired SL PRS transmissions. Paired transmissions are when UE 1 transmits SL PRS to UE 2 and (then) UE 2 transmits SL PRS to UE 1. Such transmissions are used in round trip time (RTT)-based positioning and, due to clock drifts, it is beneficial that they occur close to each other (in time).

Embodiment 3-3: The UE cannot provide a measurement report within the requested maximum response time.

Embodiment 3-4: The UE cannot measure the SL PRS at the time specified by a scheduled location time request. See, e.g., 220-3.

Note that multiple ones of Embodiments 3-1 to 3-4 could occur, and each of these could be reported if the UE is so configured. Note also that the requested maximum response time in embodiments 3-2 and 3-3 are different. There are 3 different events, which occur in different time instances: 1) Transmission of the SL PRS; 2) Measurement of the SL PRS; and 3) Transmission of the measurement report.

FIG. 2A also illustrates that there are multiple ways of applying step 3. The determination of the violation is independent from whether or not there is a value for the violation permission flag 230 (or even if there is a flag 230). The determination of the violation is, however, not independent from the actions in 250, 260, and 270. The described actions are actions that the device might take after having determined a violation, depending on the value of the flag. So, if no violation is detected, the UE uses the legacy behavior. If a violation is detected and if the flag is, e.g., FALSE (i.e., violations not allowed), the UE may report nothing or report an error/failure, which is legacy behavior. If a violation is detected and if the flag is, e.g., TRUE, (i.e., violations allowed) then the UE may continue, as described herein, e.g., by reporting the measurement and the corresponding violation. It is noted that FALSE/TRUE are merely examples, and many other techniques may be used, e.g., NotAllowed/Allowed, 0/1 (zero/one, where zero means one option and one means another), and the like. As another example, the violation permission flag 230 could use implicit or explicit indication. That is the absence of the flag is an implicit indication that violation is not allowed. Another example is that no flag is used, but a permissible violation value range may be provided, which implicitly indicates that a violation is allowed (and further defines what/how big of a violation is allowed).

It is further noted that there could be a single violation permission flag 230, which enables all of the parameters 220 to be used. There could also be one or more individual violation permission flags 230-1 through 230-5, e.g., one for each of the parameters 220-1 through 220-5. Other options are possible, such as individual violation permission flags 230 for only some of the parameters 220, and the other parameters have no flag 230, which implicitly indicates violation is not allowed for those other parameters.

For block 250, continuation of positioning procedure, e.g., transmission of SL PRS or measurement reporting, is performed only if a violation permission is indicated (to the UE), explicitly using a violation permission flag 230 or implicitly by including one or more permissible value ranges 240 in the configurations.

In another example illustrated by block 260, the UE performs continuation of positioning procedure, e.g., transmission of SL PRS or measurement reporting, only if a violation permission is indicated (to the UE), explicitly using a violation permission flag 230 or implicitly by including one or more permissible value ranges 240 in the configuration and a parameter 220 (or parameters 220) violation is inside the permissible value range(s). Both have to be true for this example.

For block 260, one example idea is that there is some requested value, but there is also provided a range of values (different from the requested one) which, if used, would constitute a violation, but a violation that the server may tolerate. Any value outside this range is not acceptable (e.g., by the server), and the UE should declare failure/error as per legacy behavior.

An example can help to explain this. Consider the following. Regarding the rest part of the comment, I don't think we need a parameter determination step. Step 1 (of FIG. 2) for this example should include the following:
1) a requested parameter configuration, i.e., some requested values for the parameters of the session;
2) a violation permission flag, which indicates to the UE whether a violation of the requested parameter values is allowed;
3) (a) permissible (violation) value range, which tells the UE what violations may be tolerated by the positioning server.

It is noted that reception of this configuration is equivalent to session parameter determination. Consider the example configuration of the BW of SL PRS transmission:
1) requested value: 80 MHz;
2) violation flag: TRUE;
3) permissible (violation) value range (e.g., a range 240-1): [60 to 100 MHz].

Furthermore, consider the following cases for the UE after the UE receives the example configuration about BW.

Case 1: The UE manages to allocate 50 MHz for SL PRS transmission. Based on the configuration, this is not a permissible violation, and the UE follows legacy behavior for error handling (e.g., abort transmission, report error).

Case 2: The UE manages to allocate 70 MHz for SL PRS transmission. Based on the configuration, this is a permissible violation, as it is within the permissible (violation) value range (e.g., a range 240-1). The UE continues with the SL PRS transmission and reports the violation to the positioning server

Case 3: The UE manages to allocate 80 MHz for SL PRS transmission. Based on this configuration, there is no violation, and the UE follows legacy behavior, i.e., transmits the SL PRS.

As a broader concept, block 270 illustrates a further example, where the UE performs continuation of positioning procedure, e.g., transmission of SL PRS or measurement reporting, for any parameters, e.g., without the (e.g., implicit or explicit) violation permission (or any corresponding permissible value ranges 240). That is, the violation permission flag 230 (and/or permissible value range 240) might not be used at all, and the UE will report any violation of the parameters 220, e.g., by a strict reading of the parameters 220 such that any deviation is reported as a violation, or allowing some small leeway such as a few percent of the parameters 220 and anything outside of that leeway is a violation.

Step 4 (of FIG. 2): The UE applies corrective measures to mitigate the effect of the violation and/or avoid such further occurrences. FIG. 2B illustrates possible examples of embodiments for step 4 of FIG. 2.

Embodiment 4-1: Upon determination that the SL PRS/measurement report transmission is delayed or is about to be delayed, the UE may raise the priority of the SL PRS/measurement report transmission. Raising the priority means that the UE is then more likely to obtain the resources, for which the UE competes. Therefore, future violations may be avoided. It is noted that this is both scheme-2 and scheme-1 (as scheme-1 allow the UE to indicate priority to other UEs and the gNB, respectively).

Embodiment 4-2: In a further embodiment, to determine the priority values 235, the UE may make use of the respective configuration provided by the positioning server in Step 1.

One or both of Embodiments 4-1 and 4-2 may be performed.

Step 5 (of FIG. 2): The UE reports the violation of the SLPP session parameters configuration. FIG. 2C illustrates possible examples of embodiments for step 5 of FIG. 2.

Embodiment 5-1: The violation indication is included in the SL PRS measurement report.

Embodiment 5-2: The violation indication includes information about the violation type, i.e., which SLPP session parameter configuration has been violated, as well as quantitative information on the violation. For example, an indication that the measurement has been delayed for X ms and/or an associated timestamp may be provided.

One or both of Embodiments 5-1 and 5-2 may be performed.

Step 6 (of FIG. 2): The positioning server, in response to reception of an indication of violation, applies one or more corrective measures to mitigate the effect of the violation, and therefore possibly avoiding further occurrences.

Embodiment 6-1: In case of an RSTD measurement time violation, i.e., the respective measurement was performed with a delay, the positioning server checks synchronization sources, such as SyncRef sources, of the involved A-UE(s) to validate the measurement. In response to the measurement not being validated: If the positioning server detects a change of a SyncRef source, it can request the UE to repeat the measurement; or, in another example, if the positioning server has information about the synchronization offset between the two SyncRef sources, the server can apply a corresponding correction to the measurement.

In further detail, SyncRef sources can include a GNSS, a gNB, a UE (referred to as a SyncRef UE), an eNB, or the like. SyncRef sources are sources that transmit synchronization signals, so that UEs can synchronize to their timing, that is, have the same notion of timing. The synchronization source of SyncRef UEs, for instance, may be the network, GNSS, another UE, or even no synchronization source.

For an RSTD measurement, the A-UEs transmitting the SL PRS must be synchronized. An example where validation may be required is as follows. Two A-UEs having the same synchronization source are configured to transmit SL PRS. The transmission of one of them is delayed because the A-UE could not reserve the required resources at an earlier time. If the synchronization source of this A-UE changes in the meantime, the RSTD measurement may be erroneous. Therefore, the positioning server may check the synchronization sources of the A-UEs to validate the measurement.

Embodiment 6-2: If one or more violation indications are received from one or more UEs, the positioning server decides to switch from session-based to session-less positioning, so that it provides a best-effort positioning service, without QoS guarantees. It is noted that a transition to session-less SL positioning, might mean the SLPP session parameters do not apply in the session-less SL positioning. For example, a target UE which was in a session and had to report measurements to the positioning server for its position to be computed, after the switch to session-less positioning, the UE will no longer provide measurement reports to the positioning server. Therefore, the parameters related to measurement reporting are no longer applicable in this example.

In further detail, the terms session-based and session-less SL positioning have not yet been strictly defined in 3GPP, but may be viewed as follows. Instead of a session, where there are some reliability guarantees, enabled by message exchange among the target UE and the other involved devices (A-UEs, positioning server), the UE is offered a positioning service in a session-less way, which is on a best-effort basis, with the UE just receiving SL PRS from A-UEs and computing its position on its own.

Turning to FIG. 3, this figure shows a block diagram of one possible and non-limiting example of a wireless network 5 that comprise user equipment 10, 10-1 and a cellular network 1 that is connected to a user equipment (UE) 10. A number of network elements are shown in the cellular network of FIG. 3: a base station 70; and a core network 90. The wireless network 5 includes multiple devices such as a positioning server 210 (e.g., LMF 99-1 and/or S-UE 10-1, as a first device), a UE 10 (e.g., as a second device), a base station 70 (e.g., as a third device), and a core network 90 (e.g., as fourth device(s)).

In FIG. 3, user equipment (UEs) 10 are in the wireless network 5 and are in wireless communication via radio links 11 and 11-1 with the base station 70 of the cellular network 1. A T-UE 10 is shown and an S-UE 10-1 is also shown, and each of these is expected to be similar in the circuitry described herein. The positioning server 210 may be the S-UE 10-1 or the LMF 99-1, which might be a network function (NF) in the core network 90 or a standalone device. The S-UE 10-1 uses a wireless link 11-1 to the base station 70, and a sidelink 111 to the T-UE 10.

The LMF 99-1 is an entity that is one element in the positioning architecture for the cellular network 1. The LMF 99-1 receives measurements and assistance information from the base station 70 and the UE (e.g., T-UE) 10 to compute the position of the UE. Due to the next generation interface between the base station (e.g., a NG-RAN in 5G) and the core network 90, a new NR positioning protocol A (NRPPa) protocol was introduced to carry the positioning information between NG-RAN (as reference 70) and LMF 99-1 over the next generation control plane interface (NG-C). These additions in the 5G architecture provide the framework for positioning in 5G. The LMF configures the UE using the LTE positioning protocol (LPP) via, e.g., an AMF. The NG RAN (as reference 70) configures the UE 10 using radio resource control (RRC) protocol over, e.g., LTE-Uu and NR-Uu.

A UE 10 is a wireless communication device, such as a mobile device, that is configured to access a cellular network. The UE 10 is illustrated with one or more antennas 28. The ellipses 2 indicate there could be multiple UEs 10 in wireless communication via radio links with the base station 70. The UE 10 includes one or more processors 13, one or more memories 15, and other circuitry 16. The other circuitry 16 includes one or more receivers (Rx(s)) 17 and one or more transmitters (Tx(s)) 18. A program 12 is used to cause the UE 10 to perform the operations described herein. For a UE 10, the other circuitry 16 could include circuitry such as for user interface elements (not shown) like a display.

The base station 70, as a network element of the cellular network 1, provides the UE 10 access to cellular network 1 and to the data network 91 via the core network 90 (e.g., via a user plane function (UPF) of the core network 90). The base station 70 is illustrated as having one or more antennas 58. In general, the base station 70 may be referred to as RAN node 70, although many will make reference to this as a gNB (gNode B, a base station for NR, new radio) instead. There are, however, many other examples of RAN nodes including an eNB (evolved Node B) or TRP (Transmission-Reception Point). The base station 70 includes one or more processors 73, one or more memories 75, and other circuitry 76. The other circuitry 76 includes one or more receivers (Rx(s)) 77 and one or more transmitters (Tx(s)) 78. A program 72 is used to cause the base station 70 to perform the operations described herein.

It is noted that the base station 70 may instead be implemented via other wireless technologies, such as Wi-Fi (a wireless networking protocol that devices use to communicate without direct cable connections), Bluetooth or other short-range communication, or even D2D communication. In the case of these radio technologies, the link 11 could be characterized as a wireless link.

Two or more base stations 70 communicate using, e.g., link(s) 79. The link(s) 79 may be wired or wireless or both and may implement, e.g., an Xn interface for 5G (fifth generation), an X2 interface for LTE (Long Term Evolution), or other suitable interface for other standards.

The cellular network 1 may include a core network 90, as a third illustrated element or elements, that may include core network functionality, and which provide connectivity via a link or links 81 with a data network 91, such as a telephone network and/or a data communications network (e.g., the Internet). The core network 90 includes one or more processors 93, one or more memories 95, and other circuitry 96. The other circuitry 96 includes one or more receivers (Rx(s)) 97 and one or more transmitters (Tx(s)) 98. A program 92 is used to cause the core network 90 to perform the operations described herein.

The core network 90 could be a 5GC (5G core network). The core network 90 can implement or comprise multiple network functions (NF(s)) 99, and the program 92 may comprise one or more of the NFs 99. A 5G core network may use hardware such as memory and processors and a virtualization layer. It could be a single standalone computing system, a distributed computing system, or a cloud computing system. The NFs 99, as network elements, of the core network could be containers or virtual machines running on the hardware of the computing system(s) making up the core network 90.

Core network functionality for 5G may include access and mobility management functionality that is provided by a network function 99 such as an access and mobility management function (AMF(s)), session management functionality that is provided by a network function such as a session management function (SMF). Core network functionality for access and mobility management in an LTE (Long Term Evolution) network may be provided by an MME (Mobility Management Entity) and/or SGW (Serving Gateway) functionality, which routes data to the data network. Many others are possible, as illustrated by the examples in FIG. 3: AMF; SMF; MME; SGW; GMLC (Gateway Mobile Location Center); LMFs (Location Management Functions); UDM (Unified Data Management)/UDR (Unified Data Repository); NRF (Network Repository Function); and/or E-SMLC (Evolved Serving Mobile Location Center). These are merely exemplary core network functionality that may be provided by the core network 90, and note that both 5G and LTE core network functionality might be provided by the core network 90. The RAN node 70 is coupled via a backhaul link 31 to the core network 90. The RAN node 70 and the core network 90 may include an NG (Next Generation) interface for 5G, or an SI interface for LTE, or other suitable interface for other radio access technologies for communicating via the backhaul link 31.

In the data network 91, there is a computer-readable medium 94. The computer-readable medium 94 contains instructions that, when downloaded and installed into the memories 15, 75, or 95 of the corresponding UE 10, base station 70, and/or core network element(s) 90, and executed by processor(s) 13, 73, or 93, cause the respective device to perform corresponding actions described herein. The computer-readable medium 94 may be implemented in other forms, such as via a compact disc or memory stick.

The programs 12, 72, and 92 contain instructions stored by corresponding one or more memories 15, 75, or 95. These instructions, when executed by the corresponding one or more processors 13, 73, or 93, cause the corresponding apparatus 10, 70, or 90, to perform the operations described herein. The computer readable memories 15, 75, or 95 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 15, 75, and 95 may be means for performing storage functions. The processors 13, 73, and 93, may be of any type suitable to the local technical environment, and may include one or more of general-purpose computers, special purpose computers, microprocessors, digital signal processors (DSPs) and processors based on a multi-core processor architecture, as non-limiting examples. The processors 13, 73, and 93 may be means for causing their respective apparatus to perform functions, such as those described herein.

The receivers 17, 77, and 97, and the transmitters 18, 78, and 98 may implement wired or wireless interfaces. The receivers and transmitters may be grouped together as transceivers.

The cellular network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities (such as network functions 99) that result from the network virtualization are still implemented, at some level, using hardware such as processors 73 and/or 93 and memories 75 and/or 95, and also such virtualized entities create technical effects.

In general, the various embodiments of the user equipment 10 can include, but are not limited to, cellular telephones (such as smart phones, mobile phones, cellular phones, and the like), tablets, portable computers, vehicles or vehicle-mounted devices for, e.g., wireless V2X (vehicle-to-everything) communication, image capture devices such as digital cameras, gaming devices, music storage and playback appliances, Internet appliances (including Internet of Things, IoT, devices), IoT devices with sensors and/or actuators for, e.g., automation applications, as well as portable units or terminals that incorporate combinations of such functions, laptop-embedded equipment (LEE), laptop-mounted equipment (LME), Universal Serial Bus (USB) dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. That is, the UE 10 could be any end device that may be capable of wireless communication and use of SLPP. By way of example rather than limitation, the UE may also be referred to as a communication device, terminal device (MT), a Subscriber Station (SS), a Portable Subscriber Station, a Mobile Station (MS), or an Access Terminal (AT).

Without in any way limiting the scope, interpretation, or application of the claims appearing below, a technical effect and/or advantage of one or more of the example embodiments disclosed herein is that interruption of the positioning service is avoided, while allowing the positioning server (or the UE) to take corrective measures. In other words, the techniques presented herein are means to enable that in case of a violation, the positioning service continues in a best effort basis (until a potential corrective action is taken). This may be very important in SL, especially in scheme-2 (i.e., UE autonomous) resource allocation where the competition of the limited time-frequency resources may lead to a large number of cases where requirements, e.g., on BW or delay, cannot be met.

The following are additional examples.

Example 1. A method, comprising: receiving, by a first device in a wireless network from a second device in the wireless network, a report of violation of one or more parameters for positioning of the second device using sidelink positioning protocol; and applying, by the first device, one or more corrective measures to mitigate an effect of the violation.

Example 2. The method according to example 1, further comprising, prior to the receiving, sending, by the first device toward the second device, configuration for the one or more parameters, the configuration comprising indication of one or more of the following: one or more parameters for sidelink positioning reference signals; one or more times between transmissions of the sidelink positioning reference signals; a scheduled location time; a measurement report response time; or a position information response time.

Example 3. The method according to example 2, wherein the configuration further indicates, explicitly using a violation permission flag or implicitly, whether a violation of the one or more parameters is allowed and is to be reported by the second device to the first device.

Example 4. The method according to example 3, wherein the configuration further indicates one or more permissible value ranges for corresponding ones of the one or more parameters, wherein the one or more permissible value ranges are ranges inside of which the second device is to determine a corresponding permissible violation for a corresponding parameter has occurred and is to send the report for reception by the first device.

Example 5. The method according to any one of examples 2 to 4, wherein the configuration further comprises one or more priority values to be applied by the second device to report transmission in response to the report or a sidelink positioning reference signal transmission being delayed.

Example 6. The method according to example any one of examples 1 to 5, wherein the report comprises a violation indication that is included in a measurement report for sidelink positioning reference signals.

Example 7. The method according to example any one of examples 1 to 6, wherein the report comprises a violation indication including information about a violation type indicating at least which of the one or more parameters has been violated, and indicating quantitative information on a corresponding violation.

Example 8. The method according to any one of examples 1 to 7, wherein applying one or more corrective measures comprises in case of a reference signal time difference measurement time violation, checking, by the first device, one or more synchronization reference sources to validate the reference signal time difference measurement, and in response to the reference signal time difference measurement not being validated: in response to the first device detecting a change of a synchronization reference source, requesting the second device to repeat the reference signal time difference measurement; or in response to the first device having information about synchronization offset between two synchronization reference sources, applying a corresponding correction to the reference signal time difference measurement.

Example 9. The method according to any one of examples 1 to 7, wherein applying one or more corrective measures comprises, in response to one or more violation indications being received from one or more second device, the first device switching from session-based to session-less positioning.

Example 10. The method according to any one of examples 1 to 9, wherein the first device comprises one of a location management function in the wireless network or another second device acting as a location server.

Example 11. A method, comprising: in a wireless network having a first device and a second device, determining, by the second device, a violation of one or more parameters has occurred for positioning of the second device using sidelink positioning protocol; and sending, by the second device to the first device, a report of the violation of the one or more parameters.

Example 12. The method according to example 11, further comprising, prior to the determining the violation, receiving, by the second device from the first device, configuration for the one or more parameters, the configuration comprising indication of one or more of the following: one or more parameters for sidelink positioning reference signals; one or more times between transmissions of the sidelink positioning reference signals; a scheduled location time; a measurement report response time; or a position information response time.

Example 13. The method according to example 12, wherein the determining the violation of any of the one or more parameters has occurred and the sending the report are performed for corresponding one or more parameters in response to those corresponding parameters having any violation.

Example 14. The method according to example 12, wherein: the configuration further indicates explicitly using a violation permission flag having a value indicating to the second device that a violation of the one or more parameters is allowed and is to be reported by the second device to the first device, or indicates implicitly to the second device that a violation of the one or more parameters is allowed and is to be reported by the second device to the first device by including one or more permissible value ranges in the configuration.

Example 15. The method according to example 12 or 14, wherein: the configuration further indicates one or more permissible value ranges for corresponding ones of the one or more parameters, wherein the one or more permissible value ranges are ranges inside of which the second device is to determine a corresponding permissible violation for a corresponding parameter has occurred; and the report comprises a violation indication including information about a violation type indicating at least which of the one or more parameters has been violated, and indicating quantitative information on a corresponding violation.

Example 16. The method according to any one of examples 12, 14, or 15, wherein: in response to a determination by the second device that a sidelink positioning reference signal transmission or a measurement report transmission for sidelink positioning reference signals is delayed or is about to be delayed, raising, by the second device, priority of a sidelink positioning reference signal transmission or a measurement report transmission for sidelink positioning reference signals based on one or more priority values.

Example 17. The method according to example 16, wherein: the configuration further comprises the one or more priority values to be applied by the second device to report transmission in response to a sidelink positioning reference signal transmission or a measurement report transmission being delayed; and the raising, by the second device, priority of the measurement report transmission for sidelink positioning reference signals is based on the one or more priority values from the configuration.

Example 18. The method according to any one of examples 12 or 14 to 17, wherein the determining the violation comprises determining there is a violation because one or more of the following is met: the second device cannot obtain sidelink positioning reference signal resources satisfying requested sidelink positioning reference signal characteristics; the second device cannot obtain sidelink positioning reference signal resources to transmit a sidelink positioning reference signal within a requested maximum response time in paired sidelink positioning reference signal transmissions; the second device cannot provide a measurement report within a requested maximum response time; or the second device cannot measure a sidelink positioning reference signal at a time specified by a scheduled location time request.

Example 19. A computer program, comprising instructions for performing the methods of any of examples 1 to 18, when the computer program is run on an apparatus.

Example 20. The computer program according to example 19, wherein the computer program is a computer program product comprising a computer-readable medium bearing instructions embodied therein for use with the apparatus.

Example 21. The computer program according to example 19, wherein the computer program is directly loadable into an internal memory of the apparatus.

Example 22. An apparatus comprising means for performing: receiving, by a first device in a wireless network from a second device in the wireless network, a report of violation of one or more parameters for positioning of the second device using sidelink positioning protocol; and applying, by the first device, one or more corrective measures to mitigate an effect of the violation.

Example 23. The apparatus according to example 22, wherein the means are further configured for performing: prior to the receiving, sending, by the first device toward the second device, configuration for the one or more parameters, the configuration comprising indication of one or more of the following: one or more parameters for sidelink positioning reference signals; one or more times between transmissions of the sidelink positioning reference signals; a scheduled location time; a measurement report response time; or a position information response time.

Example 24. The apparatus according to example 23, wherein the configuration further indicates, explicitly using a violation permission flag or implicitly, whether a violation of the one or more parameters is allowed and is to be reported by the second device to the first device.

Example 25. The apparatus according to example 24, wherein the configuration further indicates one or more permissible value ranges for corresponding ones of the one or more parameters, wherein the one or more permissible value ranges are ranges inside of which the second device is to determine a corresponding permissible violation for a corresponding parameter has occurred and is to send the report for reception by the first device.

Example 26. The apparatus according to any one of examples 23 to 25, wherein the configuration further comprises one or more priority values to be applied by the second device to report transmission in response to the report or a sidelink positioning reference signal transmission being delayed.

Example 27. The apparatus according to example any one of examples 22 to 26, wherein the report comprises a violation indication that is included in a measurement report for sidelink positioning reference signals.

Example 28. The apparatus according to example any one of examples 22 to 27, wherein the report comprises a violation indication including information about a violation type indicating at least which of the one or more parameters has been violated, and indicating quantitative information on a corresponding violation.

Example 29. The apparatus according to any one of examples 22 to 28, wherein applying one or more corrective measures comprises in case of a reference signal time difference measurement time violation, checking, by the first device, one or more synchronization reference sources to validate the reference signal time difference measurement, and in response to the reference signal time difference measurement not being validated: in response to the first device detecting a change of a synchronization reference source, requesting the second device to repeat the reference signal time difference measurement; or in response to the first device having information about synchronization offset between two synchronization reference sources, applying a corresponding correction to the reference signal time difference measurement.

Example 30. The apparatus according to any one of examples 22 to 28, wherein applying one or more corrective measures comprises, in response to one or more violation indications being received from one or more second device, the first device switching from session-based to session-less positioning.

Example 31. The apparatus according to any one of examples 22 to 30, wherein the first device comprises one of a location management function in the wireless network or another second device acting as a location server.

Example 32. An apparatus comprising means for performing: in a wireless network having a first device and a second device, determining, by the second device, a violation of one or more parameters has occurred for positioning of the second device using sidelink positioning protocol; and sending, by the second device to the first device, a report of the violation of the one or more parameters.

Example 33. The apparatus according to example 32, wherein the means are further configured for performing: prior to the determining the violation, receiving, by the second device from the first device, configuration for the one or more parameters, the configuration comprising indication of one or more of the following: one or more parameters for sidelink positioning reference signals; one or more times between transmissions of the sidelink positioning reference signals; a scheduled location time; a measurement report response time; or a position information response time.

Example 34. The apparatus according to example 33, wherein the determining the violation of any of the one or more parameters has occurred and the sending the report are performed for corresponding one or more parameters in response to those corresponding parameters having any violation.

Example 35. The apparatus according to example 33, wherein: the configuration further indicates explicitly using a violation permission flag having a value indicating to the second device that a violation of the one or more parameters is allowed and is to be reported by the second device to the first device, or indicates implicitly to the second device that a violation of the one or more parameters is allowed and is to be reported by the second device to the first device by including one or more permissible value ranges in the configuration.

Example 36. The apparatus according to example 33 or 35, wherein: the configuration further indicates one or more permissible value ranges for corresponding ones of the one or more parameters, wherein the one or more permissible value ranges are ranges inside of which the second device is to determine a corresponding permissible violation for a corresponding parameter has occurred; and the report comprises a violation indication including information about a violation type indicating at least which of the one or more parameters has been violated, and indicating quantitative information on a corresponding violation.

Example 37. The apparatus according to any one of examples 33, 35, or 36, wherein: in response to a determination by the second device that a sidelink positioning reference signal transmission or a measurement report transmission for sidelink positioning reference signals is delayed or is about to be delayed, raising, by the second device, priority of a sidelink positioning reference signal transmission or a measurement report transmission for sidelink positioning reference signals based on one or more priority values.

Example 38. The apparatus according to example 37, wherein: the configuration further comprises the one or more priority values to be applied by the second device to report transmission in response to a sidelink positioning reference signal transmission or a measurement report transmission being delayed; and the raising, by the second device, priority of the measurement report transmission for sidelink positioning reference signals is based on the one or more priority values from the configuration.

Example 39. The apparatus according to any one of examples 33 or 35 to 38, wherein the determining the violation comprises determining there is a violation because one or more of the following is met: the second device cannot obtain sidelink positioning reference signal resources satisfying requested sidelink positioning reference signal characteristics; the second device cannot obtain sidelink positioning reference signal resources to transmit a sidelink positioning reference signal within a requested maximum response time in paired sidelink positioning reference signal transmissions; the second device cannot provide a measurement report within a requested maximum response time; or the second device cannot measure a sidelink positioning reference signal at a time specified by a scheduled location time request.

Example 40. The apparatus of any preceding apparatus example, wherein the means comprises: at least one processor; and at least one memory storing instructions that, when executed by at least one processor, cause the performance of the apparatus.

Example 41. An apparatus, comprising: one or more processors; and one or more memories storing instructions that, when executed by the one or more processors, cause the apparatus at least to perform: receiving, by a first device in a wireless network from a second device in the wireless network, a report of violation of one or more parameters for positioning of the second device using sidelink positioning protocol; and applying, by the first device, one or more corrective measures to mitigate an effect of the violation.

Example 42. The apparatus according to example 41, wherein the one or more memories further store instructions that, when executed by the one or more processors, cause the apparatus at least to perform: prior to the receiving, sending, by the first device toward the second device, configuration for the one or more parameters, the configuration comprising indication of one or more of the following: one or more parameters for sidelink positioning reference signals; one or more times between transmissions of the sidelink positioning reference signals; a scheduled location time; a measurement report response time; or a position information response time.

Example 43. The apparatus according to example 42, wherein the configuration further indicates, explicitly using a violation permission flag or implicitly, whether a violation of the one or more parameters is allowed and is to be reported by the second device to the first device.

Example 44. The apparatus according to example 43, wherein the configuration further indicates one or more permissible value ranges for corresponding ones of the one or more parameters, wherein the one or more permissible value ranges are ranges inside of which the second device is to determine a corresponding permissible violation for a corresponding parameter has occurred and is to send the report for reception by the first device.

Example 45. The apparatus according to any one of examples 42 to 44, wherein the configuration further comprises one or more priority values to be applied by the second device to report transmission in response to the report or a sidelink positioning reference signal transmission being delayed.

Example 46. The apparatus according to example any one of examples 41 to 45, wherein the report comprises a violation indication that is included in a measurement report for sidelink positioning reference signals.

Example 47. The apparatus according to example any one of examples 41 to 46, wherein the report comprises a violation indication including information about a violation type indicating at least which of the one or more parameters has been violated, and indicating quantitative information on a corresponding violation.

Example 48. The apparatus according to any one of examples 41 to 47, wherein applying one or more corrective measures comprises in case of a reference signal time difference measurement time violation, checking, by the first device, one or more synchronization reference sources to validate the reference signal time difference measurement, and in response to the reference signal time difference measurement not being validated: in response to the first device detecting a change of a synchronization reference source, requesting the second device to repeat the reference signal time difference measurement; or in response to the first device having information about synchronization offset between two synchronization reference sources, applying a corresponding correction to the reference signal time difference measurement.

Example 49. The apparatus according to any one of examples 41 to 47, wherein applying one or more corrective measures comprises, in response to one or more violation indications being received from one or more second device, the first device switching from session-based to session-less positioning.

Example 50. The apparatus according to any one of examples 41 to 49, wherein the first device comprises one of a location management function in the wireless network or another second device acting as a location server.

Example 51. An apparatus, comprising: one or more processors; and one or more memories storing instructions that, when executed by the one or more processors, cause the apparatus at least to perform: in a wireless network having a first device and a second device, determining, by the second device, a violation of one or more parameters has occurred for positioning of the second device using sidelink positioning protocol; and sending, by the second device to the first device, a report of the violation of the one or more parameters.

Example 52. The apparatus according to example 51, wherein the one or more memories further store instructions that, when executed by the one or more processors, cause the apparatus at least to perform: prior to the determining the violation, receiving, by the second device from the first device, configuration for the one or more parameters, the configuration comprising indication of one or more of the following: one or more parameters for sidelink positioning reference signals; one or more times between transmissions of the sidelink positioning reference signals; a scheduled location time; a measurement report response time; or a position information response time.

Example 53. The apparatus according to example 52, wherein the determining the violation of any of the one or more parameters has occurred and the sending the report are performed for corresponding one or more parameters in response to those corresponding parameters having any violation.

Example 54. The apparatus according to example 52, wherein: the configuration further indicates explicitly using a violation permission flag having a value indicating to the second device that a violation of the one or more parameters is allowed and is to be reported by the second device to the first device, or indicates implicitly to the second device that a violation of the one or more parameters is allowed and is to be reported by the second device to the first device by including one or more permissible value ranges in the configuration.

Example 55. The apparatus according to example 52 or 54, wherein: the configuration further indicates one or more permissible value ranges for corresponding ones of the one or more parameters, wherein the one or more permissible value ranges are ranges inside of which the second device is to determine a corresponding permissible violation for a corresponding parameter has occurred; and the report comprises a violation indication including information about a violation type indicating at least which of the one or more parameters has been violated, and indicating quantitative information on a corresponding violation.

Example 56. The apparatus according to any one of examples 52, 54, or 55, wherein: in response to a determination by the second device that a sidelink positioning reference signal transmission or a measurement report transmission for sidelink positioning reference signals is delayed or is about to be delayed, raising, by the second device, priority of a sidelink positioning reference signal transmission or a measurement report transmission for sidelink positioning reference signals based on one or more priority values.

Example 57. The apparatus according to example 56, wherein: the configuration further comprises the one or more priority values to be applied by the second device to report transmission in response to a sidelink positioning reference signal transmission or a measurement report transmission being delayed; and the raising, by the second device, priority of the measurement report transmission for sidelink positioning reference signals is based on the one or more priority values from the configuration.

Example 58. The apparatus according to any one of examples 52 or 54 to 57, wherein the determining the violation comprises determining there is a violation because one or more of the following is met: the second device cannot obtain sidelink positioning reference signal resources satisfying requested sidelink positioning reference signal characteristics; the second device cannot obtain sidelink positioning reference signal resources to transmit a sidelink positioning reference signal within a requested maximum response time in paired sidelink positioning reference signal transmissions; the second device cannot provide a measurement report within a requested maximum response time; or the second device cannot measure a sidelink positioning reference signal at a time specified by a scheduled location time request.

As used in this application, the term “circuitry” may refer to one or more or all of the following:

(a) hardware-only circuit implementations (such as implementations in only analog and/or digital circuitry) and

(b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and

(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 3. A computer-readable medium may comprise a computer-readable storage medium (e.g., memories 15, 75, and 95 or other device) that may be any media or means that can contain, store, and/or transport the instructions for use by or in connection with an instruction execution system, apparatus, or device, such as a computer. A computer-readable storage medium does not comprise propagating signals, and therefore may be considered to be non-transitory. The term “non-transitory”, as used herein, is a limitation of the medium itself (i.e., tangible, not a signal) as opposed to a limitation on data storage persistency (e.g., RAM, random access memory, versus ROM, read-only memory).

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
3PP third generation partnership project
5G fifth generation
AMF access and mobility management function
AoA angle of arrival
A-UE anchor UE
BW bandwidth
D2D device to device
DL downlink (from network to UE)
E-SMLC evolved serving mobile location center
FFS for future study
GNSS global navigation satellite system
GMLC Gateway Mobile Location Center
eNB (or eNodeB) evolved Node B (e.g., an LTE base station)
gNB (or gNodeB) base station for 5G/NR
I/F interface
LMF Location Management Function
LPP LTE Positioning Protocol
LTE long term evolution
LS Liaison statement
max maximum
min minimum
MME mobility management entity
NF network function
ng or NG next generation
NR new radio
NRPPa NR Positioning Protocol A
NRF Network Repository Function
N/W or NW network
OTDOA observed time difference of arrival
Pos. positioning server
PRS Positioning Reference Signal
QOS Quality of Service
RAN radio access network
RSTD Reference Signal Time Difference
RTT round-trip time
Rx receiver
SGW serving gateway
SL sidelink
SLPP Sidelink Positioning Protocol
SMF session management function
S-UE Server UE
SyncRef synchronization reference
TOA time of arrival
TDOA time difference of arrival
TR technical report
TRP transmission-reception point
T-UE Target UE
Tx transmitter
UDM unified data management
UDR unified data repository
UE user equipment (e.g., a wireless, typically mobile device)
UL uplink (from UE to network)
UPF user plane function
WI work item

1.-58. (canceled)

59. An apparatus comprising:
a processor; and
a memory comprising computer-executable instructions that, when executed by the processor, cause the processor to perform the following operations for a positioning service:
sending, to a second device in a wireless network, parameters comprising a configuration for the parameters, the configuration comprising an indication of the following: one or more parameters for sidelink positioning reference signals; one or more times between transmissions of the sidelink positioning reference signals; a scheduled location time; a measurement report response time; a position information response time; and permissible value ranges for corresponding ones of the parameters, wherein the permissible value ranges are ranges inside of which the second device is to determine a corresponding permissible violation for a corresponding parameter has occurred;
based on the second device determining a violation of each of the parameters, receiving, from the second device, a report of violation of the parameters for positioning of the second device using sidelink positioning protocol, the report comprising a violation indication including information about a violation type indicating that each of the parameters have been violated, and indicating quantitative information on a corresponding violation, wherein the violations indicate the following have been met: the second device cannot obtain sidelink positioning reference signal resources satisfying requested sidelink positioning reference signal characteristics; the second device cannot obtain sidelink positioning reference signal resources to transmit a sidelink positioning reference signal within a requested maximum response time in paired sidelink positioning reference signal transmissions; the second device cannot provide a measurement report within a requested maximum response time; and the second device cannot measure a sidelink positioning reference signal at a time specified by a scheduled location time request; and
without interrupting the positioning service, applying corrective measures to mitigate an effect of the violations, wherein applying the corrective measures comprises:
switching from session-based to session-less positioning;
based on a reference signal time difference measurement time violation:
checking one or more synchronization reference sources to validate the reference signal time difference measurement; and
in response to the reference signal time difference measurement not being validated:
in response to detecting a change of a synchronization reference source, requesting the second device to repeat the reference signal time difference measurement; or
in response to having information about synchronization offset between two synchronization reference sources, applying a corresponding correction to the reference signal time difference measurement.

60. The apparatus of claim 59, wherein the configuration further indicates, explicitly using a violation permission flag having a value indicating to the second device that a violation of the parameters is allowed and is to be reported by the second device to the apparatus.

61. The apparatus of claim 59, wherein the configuration further indicates, implicitly, to the second device that a violation of the parameters is allowed and is to be reported by the second device to the apparatus by including one or more permissible value ranges in the configuration.

62. The apparatus of claim 61, wherein the configuration further comprises one or more priority values to be applied by the second device to report transmission in response to the report or a sidelink positioning reference signal transmission being delayed.

63. The apparatus of claim 62, wherein the report comprises a violation indication that is included in a measurement report for sidelink positioning reference signals.

64. The apparatus of claim 63, wherein the report comprises a violation indication including information about a violation type indicating at least which of the one or more parameters has been violated, and indicating quantitative information on a corresponding violation.

65. The apparatus of claim 64, further comprising one of a location management function in the wireless network or a third device acting as a location server.

66. A system comprising:
an apparatus comprising:
a processor; and
a memory comprising computer-executable instructions that, when executed by the processor, cause the processor to perform the following operations for a positioning service:
sending, to a second device in a wireless network, parameters comprising a configuration for the parameters, the configuration comprising an indication of the following: one or more parameters for sidelink positioning reference signals; one or more times between transmissions of the sidelink positioning reference signals; a scheduled location time; a measurement report response time; a position information response time; and permissible value ranges for corresponding ones of the parameters, wherein the permissible value ranges are ranges inside of which the second device is to determine a corresponding permissible violation for a corresponding parameter has occurred;
based on the second device determining a violation of each of the parameters, receiving, from the second device, a report of violation of the parameters for positioning of the second device using sidelink positioning protocol, the report comprising a violation indication including information about a violation type indicating that each of the parameters have been violated, and indicating quantitative information on a corresponding violation, wherein the violations indicate the following have been met: the second device cannot obtain sidelink positioning reference signal resources satisfying requested sidelink positioning reference signal characteristics; the second device cannot obtain sidelink positioning reference signal resources to transmit a sidelink positioning reference signal within a requested maximum response time in paired sidelink positioning reference signal transmissions; the second device cannot provide a measurement report within a requested maximum response time; and the second device cannot measure a sidelink positioning reference signal at a time specified by a scheduled location time request; and
without interrupting the positioning service, applying corrective measures to mitigate an effect of the violations, wherein applying the corrective measures comprises:
switching from session-based to session-less positioning;
based on a reference signal time difference measurement time violation:
checking one or more synchronization reference sources to validate the reference signal time difference measurement; and
in response to the reference signal time difference measurement not being validated:
in response to detecting a change of a synchronization reference source, requesting the second device to repeat the reference signal time difference measurement; or
in response to having information about synchronization offset between two synchronization reference sources, applying a corresponding correction to the reference signal time difference measurement.

67. The system of claim 66, wherein the configuration further indicates, explicitly using a violation permission flag having a value indicating to the second device that a violation of the parameters is allowed and is to be reported by the second device to the apparatus.

68. The system of claim 66, wherein the configuration further indicates, implicitly, to the second device that a violation of the parameters is allowed and is to be reported by the second device to the apparatus by including one or more permissible value ranges in the configuration.

69. The system of claim 68, wherein the configuration further comprises one or more priority values to be applied by the second device to report transmission in response to the report or a sidelink positioning reference signal transmission being delayed.

70. The system of claim 69, wherein the report comprises a violation indication that is included in a measurement report for sidelink positioning reference signals.

71. The system of claim 70, wherein the report comprises a violation indication including information about a violation type indicating at least which of the one or more parameters has been violated, and indicating quantitative information on a corresponding violation.

72. The system of claim 71, further comprising one of a location management function in the wireless network or a third device acting as a location server.

73. A method comprising:
sending, by a first device to a second device in a wireless network, parameters comprising a configuration for the parameters, the configuration comprising an indication of the following: one or more parameters for sidelink positioning reference signals; one or more times between transmissions of the sidelink positioning reference signals; a scheduled location time; a measurement report response time; a position information response time; and permissible value ranges for corresponding ones of the parameters, wherein the permissible value ranges are ranges inside of which the second device is to determine a corresponding permissible violation for a corresponding parameter has occurred;
based on the second device determining a violation of each of the parameters, receiving, from the second device, a report of violation of the parameters for positioning of the second device using sidelink positioning protocol, the report comprising a violation indication including information about a violation type indicating that each of the parameters have been violated, and indicating quantitative information on a corresponding violation, wherein the violations indicate the following have been met: the second device cannot obtain sidelink positioning reference signal resources satisfying requested sidelink positioning reference signal characteristics; the second device cannot obtain sidelink positioning reference signal resources to transmit a sidelink positioning reference signal within a requested maximum response time in paired sidelink positioning reference signal transmissions; the second device cannot provide a measurement report within a requested maximum response time; and the second device cannot measure a sidelink positioning reference signal at a time specified by a scheduled location time request; and
without interrupting the positioning service, applying corrective measures to mitigate an effect of the violations, wherein applying the corrective measures comprises:
switching from session-based to session-less positioning;
based on a reference signal time difference measurement time violation:
checking one or more synchronization reference sources to validate the reference signal time difference measurement; and
in response to the reference signal time difference measurement not being validated:
in response to detecting a change of a synchronization reference source, requesting the second device to repeat the reference signal time difference measurement; or
in response to having information about synchronization offset between two synchronization reference sources, applying a corresponding correction to the reference signal time difference measurement.

74. The method of claim 73, wherein the configuration further indicates, explicitly using a violation permission flag having a value indicating to the second device that a violation of the parameters is allowed and is to be reported by the second device to the first device.

75. The method of claim 73, wherein the configuration further indicates, implicitly, to the second device that a violation of the parameters is allowed and is to be reported by the second device to the first device by including one or more permissible value ranges in the configuration.

76. The method of claim 68, wherein the configuration further comprises one or more priority values to be applied by the second device to report transmission in response to the report or a sidelink positioning reference signal transmission being delayed.

77. The method of claim 76, wherein the report comprises a violation indication that is included in a measurement report for sidelink positioning reference signals.

78. The method of claim 77, wherein the report comprises a violation indication including information about a violation type indicating at least which of the one or more parameters has been violated, and indicating quantitative information on a corresponding violation.
